(19) United States
(12) Patent Application Publication
(10) Pub. No.: US 2008/0165176 A1
(43) Pub. Date: Jul. 10, 2008

(54) Method of Video Display and Multiplayer Gaming

(76) Inventors: Charles Jens Archer, Rochester, MN (US); Mark Gregory Megerian, Rochester, MN (US); Joseph D. Ratterman, Rochester, MN (US); Brian Edward Smith, Rochester, MN (US); Brian Paul Wallenfelt, Eden Prairie, MN (US)

Correspondence Address: IBM CORPORATION (SS/ROC);c/o STREETS & STEELE, 13831 NORTHWEST FREEWAY, SUITE 355, HOUSTON, TX, 77040, US

(21) Appl. No.: 11/536,235

(22) Filed: Sep. 28, 2006

(51) Int. Cl. G09G 5/00

(52) U.S. Cl. 345/213

(57) ABSTRACT

Systems and methods are disclosed that allow multiple users to simultaneously watch different content on the same video display. In one application, multiple players may play a multiplayer game on a single PC or game console, while simultaneously enjoy a full-screen display on a single video monitor. The video content corresponding to each player is separated into frames, which are interleaved and displayed sequentially on the video display at a controlled frequency. Each player has a personal viewing device that is synchronized with the interleaved frames, such that each user only sees the images intended for that player. Each player therefore sees a full screen display without seeing the screen content of other players.

### BACKGROUND OF THE INVENTION

1. Field of the Invention

The present invention relates to the display of multimedia content on a video display. The present invention also relates to the enablement of multiplayer video games.

2. Description of the Related Art

Video games are a popular form of interactive entertainment in which a video display, such as a monitor or a television, is the primary feedback device. A computer game is one type of video game, which is played on a personal computer (PC). The personal computer may run computer games in the form of game software written or adapted for its use, and displays the visual feedback on the computer's monitor. The game software may be stored on the computer's hard drive, or on a CD, DVD, or other readable media. A console game is another type of video game, which may be played on an electronic console that typically interfaces with a standard television set. The electronic console is itself a special purpose computer capable of running software written or adapted for its use, and which displays visual feedback on the television. The game software may be stored on a cartridge, CD, DVD, other readable media adapted for use with the electronic console. Many video games written for use on computers have similar or identical counterparts written for consoles. Some video games also emulate video games that were originally available on standalone arcade games. As used herein, the term “computer” is intended in its broad sense and includes consoles and other interactive gaming systems that include a processor.

In all video game systems, one or more input devices are provided, allowing each player to control some aspects of game play, the effects of which include generating and manipulating images on a screen. Input devices are commonly referred to as “controllers,” and include a game pad, joystick, paddle, or any other device for gaming that can receive input. Other devices, such as steering wheels for driving games and light guns for shooting games, may also be included as input devices. A keyboard, mouse, trackball, microphone or touch screen included with a personal computer may also be used as controllers for computer games.

Multiplayer games are popular in the world of interactive entertainment. Some games allow multiple players to participate remotely, each on separate computers. For example, online gaming allows players to play a game remotely with others via the Internet. Online gaming has certain disadvantages, however, including the fact that each user must have his or her own computer, at least one video display, and access to a reliable broadband connection. Online gamers also experience no real interaction with their opponents or teammates beyond what occurs on each of their electronic video displays.

Another popular type of multiplayer gaming involves multiple players playing together in person using a shared computer. A typical scenario for this type of multiplayer gaming is a group of friends gathered around a television or PC to play their favorite video game. The added social dynamic of group play in such a setting adds a dimension of enjoyment that is not available with online gaming. On conventional game systems, however, this type of multiplayer gaming also has disadvantages or limitations. Most commonly, some types of games employ a split-screen technique, wherein the screen of a video display is sectioned into parts according to the number of players. Each player is assigned a section of the screen. Each player's section of the screen has its own image content, which typically differs from that of other players. The input provided by each player controls the image content for that player, and may also affect the image content of the other players.

While convenient, a conventional split screen has some limitations. In many games, the ability for one player to see activity occurring on another player's screen is tantamount to cheating. Players may glance away momentarily to another player's section of the screen to ascertain valuable information. In a football video game, for example, one player can simply watch another player's selection of an offensive play, and anticipate that offense with a defensive move. Numerous other examples exist. This ability to “cheat” can make some games less enjoyable.

The split-screen technique also detracts from the gaming experience by reducing the size and/or changing an aspect ratio of each player's section of the screen. Ordinarily, a single player game occupies substantially all of the available viewing area of the video display. The image on the screen is as large as the video display will allow. Using split-screen techniques, however, each player's section of the screen is reduced accordingly, each occupying only a portion of the screen. In a two-person game, for example, the size of each player's section of the screen will be no greater than half of the available viewing area. In a four-person game, each player's section of the screen will be no greater than one fourth of the available viewing area. An odd number of players may produce an even less optimal result. In a three-player game, for example, the screen may still be divided into four equal parts, one of which remains unoccupied due to the lack of a fourth player. Split-screen techniques therefore result in a reduction in size, loss of detail, and a corresponding decrease in enjoyment.

An improved gaming system is therefore needed for enabling multiplayer gaming. It would be desirable to retain the advantages of playing multiplayer games on a shared computer, while avoiding the drawbacks inherent to a conventional split-screen display, such as the ability of players to cheat, as well as the reduction in size and altered aspect ratios of screen images.

### SUMMARY OF THE INVENTION

The present invention includes improved video display systems and methods allowing multiple users to simultaneously watch different video content on the same video display. Embodiments of the invention include gaming systems and methods allowing each player in a multiplayer game to enjoy a substantially full-screen view using only a single video display. In one embodiment, a system includes a computer, a video display, and first and second personal viewing devices. The computer in this embodiment may include or interface with a personal computer or a video game console. The computer interleaves frames of first and second images and sequentially displays the interleaved frames at a controlled rate on the video display. A synchronizer included with the computer synchronizes the first and second personal viewing devices with the video display for selectively enabling a first user to view only the frames of the first image and a second user to view only the frames of the second image.

### BRIEF DESCRIPTION OF THE DRAWINGS

FIG. 1 is a schematic diagram of a video system, wherein User A is viewing an image frame that is being blocked from the view of User B.

FIG. 2 is a schematic diagram of the video system of FIG, 1, wherein User B is viewing an image frame that is being blocked from the view of User A.

FIG. 3 is a schematic diagram of how separate video signals are interleaved and alternately displayed to the two users of FIGS. 1 and 2.

FIG. 4 is a flowchart illustrating one method of simultaneously displaying different video content to two users on the same video display.

FIG. 5 is a schematic diagram of an embodiment of a game system for enabling multiplayer gaming.

FIG. 6 is a flowchart describing one embodiment of a method of multiplayer gaming.

### DETAILED DESCRIPTION OF PREFERRED EMBODIMENTS

The present invention includes the provision of gaming systems and methods for improved multiplayer gaming. Each player in a multiplayer game may now enjoy a substantially full-screen view using only a single video display and a shared computer. In one embodiment, rather than splitting the video display into multiple sections, each player's screen content is instead separated into frames. The frames of all the players are interleaved and displayed sequentially on the video display at a controlled frequency. Each player is assigned his or her own personal viewing device, which is synchronized with the display of the interleaved frames, such that each user only sees the frames associated with his or her screen content. As a result, each player may see a full screen display without the ability to see the screen content of other players. The invention thereby improves the enablement and display of multiplayer games. Players may use a single, shared computer, without the expense and complication of a separate display and computers for each player. No broadband connection is necessary. Some embodiments of a gaming system according to the invention may be enabled in a standalone unit, while other embodiments may piggyback on an existing computer, including either a game console or general purpose computer. Previously existing game software may be played on a game system according to the invention, with little or no modification to the game software itself. Alternatively, new games may also be written that further take advantage of various features made possible by the present invention.

The present invention is not limited to gaming applications. More generally, the present invention provides improved video display systems and methods allowing multiple users to simultaneously watch different video content on the same video display. According to an embodiment of multi-source video display, video signals are received from multiple sources and displayed simultaneously in a full-screen format on a video display. For example, a television broadcast, a DVD player, and a VCR are examples of multimedia sources that may each provide a video signal, as well as a corresponding audio signal. Each video signal is separated into frames. The frames of the multiple video signals are interleaved in a regular, repeating order. The interleaved frames are displayed sequentially on a television or video display at a controlled rate. Each user is assigned his or her own personal viewing device, such as a wearable optical device that is synchronized with the displaying of the interleaved frames, such that each user only sees the frames associated with one of the video signals. Each user may thereby selectively view content from just one of the video signals. For example, a first user may watch a DVD while a second user watches a television broadcast on the same television. Audio related to the video signals may also be separated and delivered to each user through a personal audio device, such as headphones, so that each user both sees and hears the content from just one of the multimedia sources.

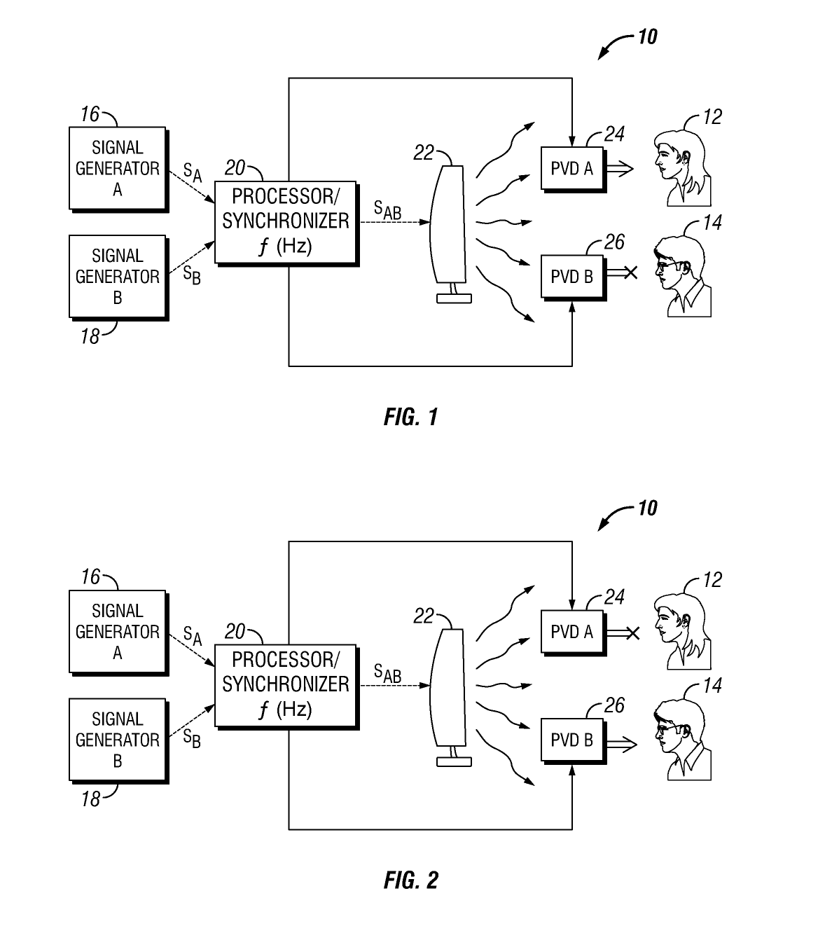

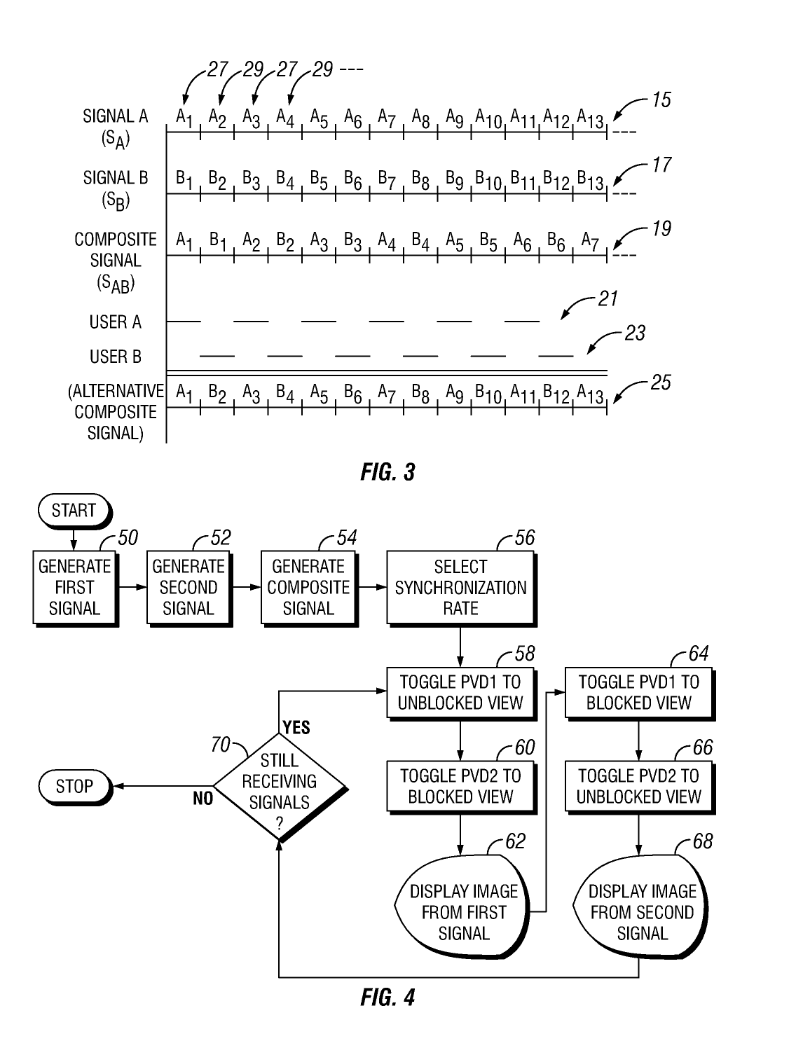

FIGS. 1-3 are schematic diagrams describing an application of the invention wherein two users may separately enjoy the content of two different video signals on the same video display. The application described with respect to FIGS. 1-3 may be extrapolated to applications involving three or more users and an equal number of video signals. FIG. 1 is a schematic diagram of a video system 10, wherein a first user (“User A”) is viewing an image frame that is being blocked from the view of a second user (“User B”). FIG. 2 is a schematic diagram of the video system 10, wherein User B is viewing an image frame that is being blocked from the view of User A. FIG. 3 is a schematic diagram of how the separate video signals are interleaved and displayed.

The video system 10 allows the first user 12 and the second user 14 to simultaneously view different video content on a shared video display 22. A first signal generator 16 (“signal generator A”) and a second signal generator 18 (“signal generator B”) each output different video signals, labeled in the figures as S_{A} and S_{B}. The first and second signal generators 16, 18 may each be, for example, a DVD player, a VCR, or a television broadcast. The first and second signal generators 16, 18 need not be the same type of device. For instance, the first signal generator 16 may be a DVD player, and the second signal generator 18 may be a VCR. The first signal generator 16 outputs the signal S_{A} and the second signal generator 18 outputs the second signal S_{B} to a computer 20. The computer 20 includes a processor and/or a synchronizer for synchronizing the display of the signals S_{A} and S_{B} with personal viewing devices (PVDs) 24 and 26.

The computer 20 selects or generates “frames” of each of the first and second signals S_{A} and S_{B}. A frame may be described as one of the many still images which compose a so-called “moving picture,” but may also include more than one still images or a discrete segment of a moving image. Frames may be contained on or captured from a video medium, and may be transmitted by a video signal. Historically, frames of a moving picture were recorded on a long strip of photographic film, and each image looked like a framed picture when examined individually. Those skilled in the art will appreciate, however, that the term “frame” has a broader meaning in multimedia today, and that individual images of a moving picture may be stored or captured in a variety of formats. Video frames are commonly stored electronically, such as on video tape or on a digital medium such as a DVD. Playback devices, such as VCRs and DVD players, generally have the capability of extracting these electronically stored frames and transmitting multimedia content frame by frame. A conventional DVD player, VCR, or other video player typically displays these images sequentially on a screen to create the appearance of continuous motion.

The computer 20 may selectively process frames contained within the video signals S_{A} and S_{B}. The invention also encompasses any present or future mediums wherein video content is initially stored in a “frameless” fashion, in which case the computer 20 may alternatively generate frames by capturing a chronological series of still images or segments of moving images from the video signals. In FIG. 3, the frames of the first signal S_{A} are labeled as A₁, A₂, A₃, and so on, as generally indicated at row 15. The frames of the second signal SB are labeled as B₁, B₂, B₃, and so on, as generally indicated at row 17. The computer 20 interleaves the frames of the video signals S_{A} and S_{B} into a composite video signal “S_{AB}.” The resulting frames of composite signal S_{AB} alternate between consecutive frames of the first signal S_{A} and the consecutive frames of the second signal S_{B}. Thus, the frames of the composite signal are frames A₁, B₁, A₂, B₂, A₃, B₃, and so on, as generally indicated at row 19, thus preserving the chronological order of the signals S_{A} and S_{B}.

The composite signal S_{AB} is output to and displayed on a video display 22 at a selected frequency. To the naked eyes of the first user 12 and the second user 14, the video display might look blurry and nonsensical, because the display has the effect of alternating back and forth between the first and second video signals, each having different image content. This is resolved using the first personal viewing device (“PVDA”) 24 provided to first user 12 and the second personal viewing device (“PVDB”) 26 provided to the second user 14. The PVDs 24, 26 selectively block light from the display 22 from reaching the users 12, 14, so that the first user 12 only sees the content of the first signal S_{A} (A₁, A₂, A₃ . . . ), and the second user 14 only sees the content of the second signal S_{B} (B₁, B₂, B₃ . . . ). To the first user 12, the video display 22 appears to be displaying only the signal S_{A} from the first signal generator 16. To the second user 14, the video display 22 appears to be displaying only the signal S_{B} from the second signal generator 18. To each user 12, 14 the experience is the same as or similar to watching the content of just one of the video signals S_{A} and S_{B}. For example, if the first signal generator 16 is a DVD player and the second signal generator 18 is a television channel, the first user 12 may have the experience of watching a DVD on the display 22 and the second user 14 may have the experience of watching a TV show on the display 22.

A number of devices are known in the art for selectively blocking light that may be adapted for use with the computer 20 according to the invention. For example, there are known ways to electrically or chemically manipulate light through a glass lens to alternate the lens between a transparent condition and a non-transparent or substantially opaque condition. These devices include so-called shutterglasses and LCD glasses. Shutterglasses are generally worn like other forms of eyewear, and include a left eye lens and a right eye lens that is electronically controlled to selectively block and unblock light from passing through each lense. Typically, shuggerglasses alternate back and forth between blocking light through the left lens and right lens, which in some applications creates a three-dimensional viewing effect. However, in embodiments of the present invention, both lenses are generally intended to be simultaneously blocked during the display of images that are not part of that user's video. Alternatively, there are known ways to mechanically control light passing through a glass lens, such as with a shutter used to alternately block and pass light. Any of these devices may be electronically controlled by the computer 20 to control their frequency of alternating between a blocked and unblocked condition, in synchronization with the display of associated frames on the video display 22.

Referring again to FIG. 1, the PVDA 24 is passing light from the video display 22 to the first user 12, and the PVDB 26 is blocking light from the video display 22 to the second user 14. This is also indicated schematically in FIG. 3 at the intersections of columns 27 with rows 21 and 23. In FIG. 2, the PVDA 24 is instead blocking light and the PVDB 26 is passing light. This is also indicated schematically in FIG. 3 at the intersections of columns 29 and rows 21, 23. The computer 20 synchronizes the PVDs 24 and 26 with the display of the composite video signal SAB, so that light from the display 22 passes through the PVDA 24 only when frames A₁, A₂, A₃, etc. are displayed (FIG. 1), and light from the display 22 passes through the PVDB 26 only when frames B₁, B₂, B₃, etc. are displayed (FIG. 2). Thus, the first user 12 sees video content that is equivalent or at least similar to that generated by the first signal generator 16. Likewise, the second user 14 sees video content that is the same as or similar to that generated by the second signal generator 18. Consequently, users A and B may simultaneously enjoy different video content on the same video display 22.

The computer 20 controls the frequency at which the composite signal S_{AB} is displayed. The frequency may be defined herein as the inverse of the time period between the display of consecutive frames from a common signal generator. An appropriate frequency for displaying the composite signal S_{AB} may be selected according to a number of parameters, including the refresh rate of the video display 22 and the number of users (in this example, two users). Under a wide range of conditions, it has been shown that most users will experience flicker below a rate of 16 frames per second. However, the appearance of flicker also depends somewhat on the intensity of an image displayed. At a given frequency, a brighter image may be retained by a human retina for a longer period of time, reducing the appearance of flicker. Thus, the selected frequency will generally be suitable if it is 10 Hz or greater, with a more typical frequency being 16 Hz or greater. Furthermore, the number of users and the refresh rate of the display may also affect the frequency. For example, the refresh rate of the video display 22 may determine an upper limit for the frequency.

The frequency of displaying the frames of composite signal S_{AB} also affects the speed of the video content each user 12, 14 sees. Due to the interleaving of A frames and B frames, if the frequency of the composite signal S_{AB} is the same as the frequency at which signals S_{A} and S_{B} would normally be played back, then the video seen by users 12, 14 will appear to be played at half speed. One way to display the content to each user 12, 14 at full speed is to double the frequency of playback of the composite signal S_{AB}. Doubling the frequency may be more acceptable in some situations, such as with systems having fewer users and a higher refresh rate. Doubling the frequency may be less acceptable or impossible in other situations, such as with many users (such as in a four player game) and a lower refresh rate.

Another way to generate full-speed display to each user 12, 14 is by displaying the alternate composite signal schematically shown at row 25 of FIG. 3. The alternate composite signal 25 is formed by interleaving every other frame of the first signal S_{A} with every other frame of the second signal S_{B}. Thus, the alternative composite signal 25 consists of frames A₁, B₂, A₃, B₄, and so on. The alternative composite signal 25 may then be displayed at the same frequency at which the first or second signals, S_{A} or S_{B}, are shown in FIG. 3. A possible disadvantage is that video content seen separately by users 12 and 14 would contain half the information. However, within a range of playback speeds, this difference in information content may be imperceptible or at least not bothersome. By analogy, VCRs typically provide the option of recording video at different speeds. Recording video at slower speeds (longer recording time on a given tape length) reduces the image content recorded in exchange for the longer recording time. However, this difference is generally not noticeable during playback, or at least well tolerated by most users.

FIG. 4 is a flowchart illustrating a method of simultaneously displaying different video content to two users on the same video display. In step 50, a first signal is generated. Examples of generating the first signal include initiating playback of a DVD or VCR. Another example of generating the first signal is outputting a signal from a computer game corresponding to a first player. In step 52, a second signal is generated. Examples of the second signal include the output from a DVD or VCR, or a signal from the computer game corresponding to a second player. In step 54, a composite signal is generated from the first and second signals, whereby frames of the first signal are interleaved with frames of the second signal, preserving a chronological order of the first and second signals. In step 56 a synchronization rate is selected, which may simply be a frequency expressed in hertz (Hz). The frequency may be selected according to factors such as the refresh rate of a video display and the number of signals (in this example, two signals). Steps 58-62 enable a first user to independently view a frame of the composite signal that corresponds to the first signal while preventing a second user from seeing that frame. In step 58 a first PVD (“PVD1”) is set to allow the passage of light through PVD1. Substantially simultaneously, light from the video display is blocked by a second PVD (“PVD2”) in step 60. In step 62, an image from the first signal is displayed while PVD1 is unblocked and PVD2 is blocked. The first user therefore sees a frame of the first signal, while the second user does not. Steps 64-68 enable the second user to independently view the next frame of the composite signal that corresponds to the second signal, while preventing the first user from seeing that frame. In step 64, PVD1 is set to block light from the video display. Substantially simultaneously, PVD2 is toggled to an unblocked view in step 66. In step 68, the frame is displayed while PVD1 is blocked and PVD2 is unblocked. As indicated by step 70, steps 58-68 are repeated, such that the first user sees consecutive or at least chronologically arranged frames derived from the first signal, and the second user sees consecutive or at least chronologically arranged frames derived from the second signal. Thus, the first user effectively watches the video content of the first signal and the second user effectively watches the video content of the second signal.

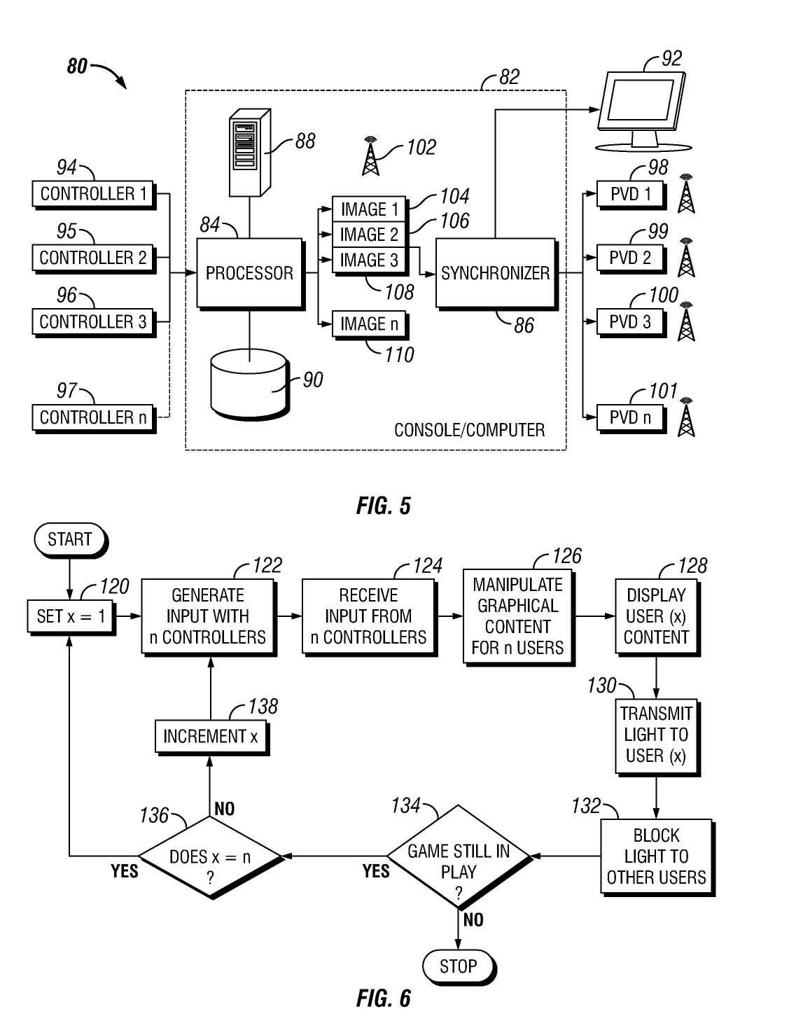

FIG. 5 is an embodiment of a game system 80 for enabling multiplayer gaming according to the invention. A computer 82 may be a personal computer (PC) or a video game console. The computer 82 includes a processor 84 which may include one or more CPUs. A synchronizer 86 may be a component of the processor 84 included with computer 82. Alternatively, the synchronizer 86 may be included with a separate device that interfaces with a conventional PC or console. A game ROM 88 is game software embodied in a cartridge, DVD, or other media. Embodiments of the invention may be used with existing games, so the game ROM 88 may desirably be a conventional, existing unit of game software. A memory device 90, such as a hard drive, is included for storage and selective retrieval of game data. In embodiments wherein the computer 82 is a conventional PC, the storage device 90 may be a hard drive of the PC, and the ROM 88 may be loaded and stored on the hard drive, so that the game may access the contents of the ROM 88 directly from the hard drive 90. A single video display 92 interfaces with the computer 82 to provide visual feedback during game play. Typically, the display 92 is a monitor, such as a conventional CRT or LCD display, or a television. The display 92 could also be a plurality of structurally separate displays combined to produce an enlarged field of view, such as a dual-monitor computer display. Alternatively, the invention may include embodiments having multiple displays, wherein multiple users obtain private viewing on each display. This could include, for example, first and second users sharing a first display while third and fourth users share a second display.

Conceptually, any number “n” of players may play a multiplayer game according to the invention. As a practical matter a typical game may involve between two and four players. Many current game ROMs 88 limit the number of players that may be involved in a game. Furthermore, factors such as the refresh rate of the video display 92 may affect the number of players that can play simultaneously without a distracting level of flicker. In one example, optimal viewing may be provided with a refresh rate of at 72 Hz per player. For example, a two player game would then be displayed at about 140 Hz, and a 3 player game could be displayed at around 200 Hz. As display technology continues to evolve, as it has historically, corresponding improvements in refresh rates will further optimize video display for each user, as well as enable an increasing numbers of players to play multiplayer games according to the present invention.

A plurality of controllers 94-97 and a plurality of PVDs 98-101 are provided for the n players. Thus, the controllers 94-97 are labeled from “Controller 1” to “Controller n,” and the PVDs 98-101 are labeled from “PVD 1” to “PVD n.” One of the controllers 94-97 and one of the PVDs 98-101 may each be assigned to each player during a game. Each controller 94-97 may be a conventional controller, such as a joystick, game pad, keyboard, mouse, trackball, steering wheel, or combination thereof. The controllers 94-97 may interface with the computer 82 in any of a wired or wireless connection known in the art. Each PVD 98-101 may be, for example, a wearable shutterglass or other device that selectively blocks light from passing through it. The PVDs may interface with the computer 82 using a corded connection, or, as shown, with an optional wireless connection provided by a wireless access point 102.

During play of a multiplayer game, each player (1 to n) selects or is assigned one of the controllers 94-97 and one of the PVDs 98-101. As the multiplayer game proceeds, the processor 84 will process image content for each player. That image content for each player is what typically would be otherwise displayed on each player's section of a split screen using a conventional game system. Image content for each player (1 to n) is stored as images 104-110, which are labeled as Image 1, Image 2, Image 3, and Image n, corresponding to each player (1 to n). Images 104-110, and subsequent images, are manipulated in response to input from each player via the controllers 94-97, as well as in response to other aspects of game play according to the ROM 88.

To illustrate, if the ROM 88 simulates an American football video game, each player's image content may include graphical representations of different portions of a football field. Image content for a player on a defensive team may include information proprietary to the defense. Likewise, image content for a player on an offensive team may include information and graphical content proprietary to the offense. The processor 84 processes input from the controllers 94-97 according to input from the controllers 94-97, as governed by the ROM 88. For example, player 1 on an offensive team may push “up” on a joystick to move his electronic counterpart (e.g. an offensive football player) forward toward the defense's goal line. In response, image 104 is continuously updated to include player 1's position on the football field, as well as other information such as current yardage and scoring stats, and information proprietary to the offense such as what pre-designed “play” the offense is attempting to follow. Likewise, each of the other images 106-110 is continuously updated.

Typically, each image 104-110 is unique, in at least some respect, for each player 1 to n. The processor 84 may continuously keep track of and manipulate the images 104-110. This may be done at regular intervals. For example, the processor 84 may update images 104-110 several times per second. Each time the images are updated, each updated image may be treated by the processor as an equivalent “frame,” analogous to the frames discussed in connection with FIGS. 1-3. Alternatively, the images 104-110 may be accessed at regular intervals or at a specified frequency, and the current image at the moment it is accessed is displayed or otherwise treated as one frame. Displaying the consecutive frames of each player's image therefore creates a moving picture.

According to the invention, a full-screen representation of the images 104-110 for each player (1 to n) may be displayed on the video display 92. In this embodiment, the processor 84 interleaves the frames of images 104-110 by sequentially displaying them at a controlled frequency. For example, the processor 84 may output the current frame for image 104, followed by the current frame for image 106, then image 108, and then image 110. This cycle may be repeated several times per second. The frames of images 104-110 are thereby interleaved. The synchronizer 86 synchronizes the cyclical display of images 104-110 with the PVDs 98-101, so that each player (1 to n) sees only the image assigned to that player. For example, PVD1 98 only allows light to pass to the eyes of player 1 while image 104 is being displayed, PVD2 99 only allows light to pass to the eyes of player 2 while image 106 is being displayed, and so on. As the processor cycles through the current frame of each image 104-110 several times per second, each player (1 to n) sees what appears to be a moving picture, to the extent that the images 104-110 change from frame to frame. The frames are displayed and synchronized with the PVDs 98-101, so that each player enjoys a full screen view of the game.

It should be noted that some games may pit one group or team of players against another group. For example, players 1 and 2 may compete as a team against other players. In such a situation, players 1 and 2 may share the same image. Typically, the game, itself, as embodied in the ROM 88, may control this aspect. For example, where players 1 and 2 are intended to see the same image content on the video display 92, the processor may compute image 104 and image 106 to be the same image. The frames for images 104 and 106, though identical, would still be output at separate instants, analogous to being output to separate sections of a conventional split screen. Alternatively, it may be desired in some instances for players 1 and 2 to see the frame of the same image, rather than frames of different but identical images. In that case, the processor 84 may selectively unblock the PVDs 98 and 99 when frames of a certain image are displayed, so that players 1 and 2 both see the same frames. This would desirably reduce the number of frames displayed in a cycle. For example, in a four player game pitting a two player team against another two player team, and wherein each team is intended to see the same image on the video display 92, the number of frames displayed in a cycle could be reduced from four frames to two frames, thereby allowing an increase in the frequency or duration of each frame.

FIG. 6 is a flowchart describing one embodiment of a method of multiplayer gaming according to the invention. The method envisions a plurality of players 1 to n, each being assigned a corresponding controller and a corresponding PVD. In step 120, the value of a counter variable “x” is initialized. According to step 122, each player selectively generates electronic input using controllers. For example, each player operates his or her controller during play, and by pressing buttons, moving levers, turning wheels, and so forth, electronic signals are generated that affect game play. A computer or console receives this input in step 124, and manipulates image content for each player in response in Step 126. Video game software stored as a ROM may dictate how the player input is processed. In step 128, the image content for user x is displayed on a video display. For example, x is initially set to 1 in step 120, so the current frame for a user 1 is first displayed. In step 130, while the current frame for user x is displayed on the video display, light from the video display is allowed to pass to user x. Typically, this is done by switching the PVD of user x to an unblocked condition, whereby light is allowed to pass to the player's eyes. Simultaneously, in step 132, light is blocked to each of the other users. Thus, only player x sees the current frame for image x on the video display.

The method of FIG. 6 is generally in the form of a loop. As indicated by step 134, the loop continues for as long as the game is still in play. In step 136, if x is less than n, then x is incremented in step 138, so that the current frame of the next image is displayed and exclusively viewed by the corresponding player in steps 122 through 132. If x=n in step 136, then the current frame of the nth image has already been displayed to the nth player, and the process returns to step 120. Thus, the images 1 to n are sequentially displayed one at a time and viewed by the corresponding player 1 to n through the corresponding PVD. Player 1 views the frame of image 1, player 2 views the frame of image 2, and so on, up to the nth player and nth frame, and cycle repeats at a controlled rate. As a result, each player views only what is essentially the image content corresponding to that player, without seeing the images corresponding to the other players. Again, each frame may be displayed full-screen on the video display, rather than in a split screen format.

Video content usually includes an accompanying audio component. For example, most movies for the past several decades have included an audio track. Likewise, games often generate much of their excitement from the sounds that accompany the visual feedback. The invention further encompasses embodiments wherein audio is separately fed to users. For example, when two users are each watching separate movies, one user would typically not want the distraction of hearing the audio that accompanies the other user's movie. To avoid this distraction, audio corresponding to one video signal could be routed to the intended user via a personal listening device (PLD). The PLD could be embodied, for example, in the form of a headset or pair of headphones that would allow a user to privately enjoy the audio that accompanies the video content being enjoyed by that user. In one embodiment, the PLD could be integrated with a PVD. A single piece of headwear could include shutter glasses or another form of PVD, with an integrated set of headphones. However, it should be recognized that the audio signals are preferably transmitted in a continuous signal that does not remove any of the audio content, rather than being blocked and unblocked in concert with the video display. This can be accomplished in a conventional manner using separate wires or separate wireless transmission frequencies.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
interleaving frames of first and second images;
sequentially displaying the interleaved frames at a controlled rate on a video display;
synchronizing a first personal viewing device for selectively enabling a first user to view only the frames of the first image on the video display; and
synchronizing a second personal viewing device for selectively enabling a second user to view only the frames of the second image.

2. The method of claim 1, wherein the controlled rate is a frequency of greater than about 10 Hz.

3. The method of claim 1, wherein the step of synchronizing the first personal viewing device comprises selectively blocking light from passing from the video display to the first user so that only frames of the first image are transmitted to the first user.

4. The method of claim 1, further comprising routing a first audio signal accompanying the first image to the first user and separately routing a second audio signal accompanying the second image to the second user.

5. The method of claim 1, further comprising:
interleaving a third image with the first and second images; and
synchronizing a third personal viewing device for selectively enabling a third user to view only the frames of the third image.

6. The method of claim 1, further comprising synchronizing a third personal viewing device for selectively enabling a third user to view only the frames of the first image.

7. The method of claim 1, further comprising:
manipulating the first image in response to electronic input from the first user; and
manipulating the second image in response to electronic input from the second user.

8. The method of claim 7, further comprising receiving the electronic input from the first user and the second user through one or more input devices selected from the group consisting of a joystick, a game pad, and a paddle.

9. The method of claim 1, further comprising:
manipulating the first image in response to electronic input from the second user; and
manipulating the second image in response to electronic input from the first user.

10. The method of claim 1, further comprising selectively outputting a first audio signal corresponding to the first image to only the first user.

11. The method of claim 1, wherein the step of interleaving the frames of the first and second images comprises interleaving the frames of a first video signal with the frames of a second video signal.

12. A machine-accessible medium containing instructions, which when executed by a machine, cause the machine to perform operations, comprising:
interleaving frames of first and second images;
sequentially displaying the interleaved frames at a controlled rate on a video display;
synchronizing a first personal viewing device for selectively enabling a first user to view only the frames of the first image on the video display; and
synchronizing a second personal viewing device for selectively enabling a second user to view only the frames of the second image.

13. The machine-accessible medium of claim 12, wherein the controlled rate is a frequency of greater than about 10 Hz

14. The machine-accessible medium of claim 12, wherein the instructions comprise video game software, and the machine comprises one of a personal computer and a video game console.

15. The machine-accessible medium of claim 12, wherein the operation of synchronizing the first personal viewing device comprises selectively blocking light from passing from the video display to the first user so that only frames of the first image are transmitted to the first user.

16. The machine-accessible medium of claim 12, wherein the first personal viewing device comprises a pair of shutterglasses.

17. A system, comprising:
a video display;
a computer for interleaving frames of first and second images and sequentially displaying the interleaved frames at a controlled rate on a video display;
a first personal viewing device and a second personal viewing device for selectively viewing the video display; and
a synchronizer included with the computer for synchronizing the first and second personal viewing devices with the video display for selectively enabling a first user to view only the frames of the first image a second user to view only the frames of the second image.

18. The system of claim 17, further comprising:
first and second input devices configured for inputting signals to the computer, wherein the computer manipulates the first image in response to the signals from the first input device and manipulates the second image in response to the signals from the second input device.

19. The system of claim 17, wherein the first and second input devices are selected from the group consisting of a joystick, a game pad, a paddle, a steering wheel, a mouse, a trackball, and a keyboard.

20. The system of claim 17, wherein at least one of the first and second personal viewing devices comprise shutterglasses.
